(19) United States
(12) Patent Application Publication
(10) Pub. No.: US 2009/0086114 A1
(43) Pub. Date: Apr. 2, 2009

(54) LIQUID CRYSTAL DISPLAY DEVICE EQUIPPED WITH TOUCH PANEL AND MANUFACTURING METHOD THEREOF

(75) Inventors: Takayuki Higuchi, Mobara (JP); Yasuyuki Mishima, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/237,473

(22) Filed: Sep. 25, 2008

(30) Foreign Application Priority Data
Sep. 28, 2007 (JP) 2007-253029

(51) Int. Cl. G02F 1/1333

(52) U.S. Cl. 349/12

(57) ABSTRACT

(Object) To provide a configuration where reduction in the thickness of a liquid crystal display device is possible and the problem with visibility as in the case where a touch panel is mounted on a liquid crystal display panel can be solved.

(Means for Achieving Object) A liquid crystal display device is provided with a liquid crystal display panel and a resistance film type touch panel 11 mounted on the liquid crystal display panel, the liquid crystal display panel is an IPS type liquid crystal display panel, a transparent conductive film is provided on the surface of the smaller substrate forming the liquid crystal display panel, a polarizing plate is provided on this transparent conductive film, the space between the polarizing plate and the touch panel 11 is filled in with an adhesive, and the transparent conductive film provided on the surface of the smaller substrate is provided in such a state as not to be grounded.

The present application claims priority over Japanese Application JP 2007-253029 filed on Sep. 28, 2007, the contents of which are hereby incorporated into this application by reference.

### BACKGROUND OF THE INVENTION

(1) Field of the Invention

The present invention relates to a liquid crystal display device and, in particular, to a liquid crystal display device where a touch panel is mounted on a liquid crystal display panel.

(2) Related Art Statement

FIG. 9 is a diagram showing the configuration of a touch panel 11 provided above a liquid crystal display panel according to the prior art.

This liquid crystal display panel according to the prior art is a so-called IPS type liquid crystal display panel having a configuration where an electrode for controlling a liquid crystal layer is provided on one substrate from among a pair of substrate that form the liquid crystal display panel.

The liquid crystal display panel is formed of a larger transparent substrate and a smaller transparent substrate 2 layered on top of each other with a liquid crystal layer sandwiched in between. In the case of IPS type liquid crystal display panels, the larger transparent substrate 3 is referred to as TFT substrate, and has TFT's provided thereon, and the smaller transparent substrate 2 is referred to as color filter substrate.

A driver chip 5 for transmitting a signal for controlling the liquid crystal layer is placed in a portion of the larger transparent substrate 3 where the smaller transparent substrate 2 does not overlap.

In addition, a flexible printed circuit board 6 (hereinafter referred to as FPC 6) for transmitting a signal to the driver chip 5 is provided on the side of the larger transparent substrate 3.

In addition, the liquid crystal display panel is provided on the upper side of a mold frame 7, and a light guiding plate 19 which forms a backlight is provided on the lower side of the mold frame 7. Here, in one end portion of the light guiding plate 19, a light source 18 (for example LED's) is provided on the flexible printed circuit board extending from the FPC 6.

In addition, a touch panel 11 provided above the liquid crystal display panel is also connected to the flexible printed circuit board 14 (hereinafter referred to as FPC 14) extending from the FPC 6.

Here, in the case where the liquid crystal display panel is an IPS type liquid crystal display panel, no electrodes are provided on the smaller transparent substrate 2, and thus, the transparent substrate 2 is charged with static electricity, and this static electricity negatively affects the liquid crystal display. In order to solve this problem, a transparent conductive film (for example of ITO) is provided on the upper surface of the transparent substrate 2. In addition, in order to remove the static electricity with which the transparent conductive film is charged, the transparent conductive film is connected to a terminal portion 80 formed on the transparent substrate 3 through a conductive resin 4. Here, a terminal formed on the transparent substrate 3 is connected to a wire of the FPC 6 so as to be connected to the ground via the wire of the FPC 6, and thus, static electricity is removed.

FIG. 10 is a diagram showing a liquid crystal display panel according to the prior art as viewed from the top.

A liquid crystal display panel formed of a larger transparent substrate 3 and a smaller transparent substrate 2 is mounted on a mold frame 7 with the center portion removed in order to irradiate the liquid crystal display panel with light from the backlight provided on the rear surface.

A transparent conductive film 8 is formed on the upper surface of the smaller transparent substrate 2, and a polarizing plate 1 is provided on this transparent conductive film 8. A conductive resin 4 is provided in order to connect a terminal portion 80 provided on the larger transparent substrate 3 to the transparent conductive film 8.

The following patent document describes prior art according to which a transparent conductive film is formed on an IPS type liquid crystal display device in order to remove static electricity.
(Patent Document 1) Japanese Unexamined Patent Publication H11 (1999)-149085

### SUMMARY OF THE INVENTION

### (Problem to Be Solved by the Invention)

FIG. 11 is a diagram showing the liquid crystal display panel according to the prior art as viewed from the side, and shows a configuration where a touch panel 11 is provided above the liquid crystal display panel.

As shown in FIG. 11, a smaller transparent substrate 2 overlaps with a larger transparent substrate 3 in liquid crystal display panels. In addition, a transparent conducive film (not shown) is provided on the smaller transparent substrate, and furthermore, a polarizing plate 1 is provided on this transparent conductive film. The figure shows that the transparent conductive film is connected to a terminal portion 80 formed on the transparent substrate 3 via a conductive resin 4. Here, there is a certain space (air layer) between the touch panel 11 and the liquid crystal display panel. A glass substrate having a thickness of 0.3 mm to 0.5 mm is used as the transparent substrate 3, and likewise a glass substrate having a thickness of 0.3 mm to 0.5 mm is used as the transparent substrate 2. The polarizing plate 1 has a thickness of 0.13 mm. There is an error margin of approximately 25 μm in the manufacture with this polarizing plate 1, and thus, the actual thickness of the used polarizing plate 1 is 0.13 mm±25 μm.

A method for removing the charge between the polarizing plate and the transparent conductive film 8 is described below in reference to FIG. 12. In the manufacturing step of pasting a polarizing plate 1 to the liquid crystal display panel, the protective sheet is peeled from the polarizing plate 1. Thus, the polarizing plate 1 of the liquid crystal display panel becomes charged with static electricity when the polarizing plate 1 is peeled from the protective sheet. As shown in FIG. 12, the static electricity with which the polarizing plate 1 is charged is conveyed through the transparent conductive film 8 and the conductive resin 4 to the terminal portion 80. The terminal portion 80 is connected to a controller IC via the wire 9 on the transparent substrate 3 and the wire on the FPC 6 so as to be grounded, and this configuration allows the static electricity with which the transparent conductive film and the polarizing plate are charged to be removed.

In recent years, the demand for thinner liquid crystal display panels and thinner liquid crystal display devices as a whole has been increasing.

In accordance with one method for efficiently reducing the thickness of liquid crystal display panels, the transparent substrates which form the liquid crystal display panel are made thinner through polishing. However, in the process of reducing the thickness of the transparent substrates, the conductive resin 4 becomes higher than the transparent substrate 2 and the polarizing plate 1.

In recent years there has also been demand for liquid crystal display panels having higher visibility. As shown in FIG. 11, in the case where a touch panel 11 is provided above a liquid crystal display panel, there is an air layer between the touch panel 11 and the liquid crystal display panel, and therefore, light is reflected from the interface between the touch panel and the air layer, due to the difference in the index of refraction between the substrate and the air layer in the touch panel, and thus, a problem arises, such that the visibility is lower.

The present invention is provided in order to solve these problems, and an object is to provide a configuration where the liquid crystal display device is thinner and there is no such problem with the visibility as in the case where a touch panel is mounted on a liquid crystal display panel.

### (Means for Solving Problem)

One aspect of the present invention provides an IPS type liquid crystal display device inside which a touch panel is mounted having a liquid crystal display panel and a resistance film type touch panel mounted on the liquid crystal display panel, wherein the above described liquid crystal display panel is an IPS type liquid crystal display panel formed of two substrates of a different size and a liquid crystal layer provided between the two substrates, and electrodes for controlling the above described liquid crystal layer are provided on the larger substrate, a transparent conductive film is formed on the surface of the smaller substrate and a polarizing plate is further provided on the transparent conductive film, the space between the polarizing plate provided on the above described smaller substrate and the above described touch panel is filled in with an adhesive, and the transparent conductive film provided on the surface of the above described smaller substrate is in such a state as not to be grounded.

In this configuration, an IPS type liquid crystal display device inside which a touch panel is mounted where reduction in the thickness of the liquid crystal display device is possible and the problem with the visibility as in the case where a touch panel is mounted on a liquid crystal display panel can be solved can be provided.

According to the present invention, when the transparent substrate which forms the liquid crystal display panel is thin, the problem to be solved by the invention becomes significant, and therefore, the invention is characterized in that the above described smaller substrate has a thickness of 0.1 mm or more and 0.2 mm or less. This is because it is not necessary to reduce the thickness of the transparent substrate as in the present invention in the case of an IPS type liquid crystal display device inside which a touch panel is mounted and it is not necessary to reduce the thickness, and accordingly, the conductive resin does not become taller than the transparent substrate (smaller transparent substrate), and thus, no such problem as in the present invention arises.

Furthermore, the present invention is characterized in that the adhesive with which the space between the polarizing plate provided on said smaller substrate and said touch panel is filled in with a UV curing resin. The invention is also characterized in that the UV curing resin has a thickness of 0.05 mm±0.04 mm (error margin). This is because in the case where the adhesive (UV curing resin) has a sufficient thickness, the conductive resin can be prevented from making contact with the touch panel, and thus, the problem to be solved by the present invention does not arise.

Furthermore, the present invention is also characterized in that the above described polarizing plate has a thickness of 0.12 mm±25 μm (error margin). This is because in the case where a polarizing plate which is thinner than in the prior art is used, as in the present invention, in order to meet the demand for thinner displays, such a problem arises as in the present invention.

Another aspect of the present invention provides a liquid crystal display device inside which a touch panel is mounted having a liquid crystal display panel and a resistance film type touch panel mounted on the liquid crystal display panel, wherein the above described liquid crystal display panel is a liquid crystal display panel formed of two substrates of a different size and a liquid crystal layer between the two substrates, and a pair of electrodes for controlling the above described liquid crystal layer is provided on the larger substrate, a transparent conductive film is formed on the surface of the smaller substrate and a polarizing plate is further provided on the transparent conductive film, the polarizing plate provided on the above described smaller substrate and the above described touch panel are pasted together with an adhesive, and the transparent conductive film provided on the surface of the above described smaller substrate is in an electrically floating state.

In this configuration also, reduction in the thickness of the liquid crystal display is possible, and a liquid crystal display device inside which a touch panel is mounted where the problem with the visibility as in the case where a touch panel is mounted on the liquid crystal display panel can be solved can be provided. Here, according to the present aspect, electrically floating state means a state where the transparent conductive film is not electrically connected to anything, as opposed to a state in which the transparent conductive film is grounded via the conductive resin and the terminal portion, as in the prior art. Here, the transparent substrate, the thickness of the polarizing plate and the thickness of the UV curing resin, which is the adhesive, are the same as in the previous aspect. This is the same in the following aspects.

Still another aspect of the present invention provides a manufacturing method for an IPS type liquid crystal display device having an IPS type liquid crystal display panel and a resistance film type touch panel mounted on the liquid crystal display panel, wherein the above described liquid crystal display panel is formed of two substrates of a different size and a liquid crystal layer provided between the two substrates, a transparent conductive film is formed on the smaller substrate, a polarizing plate is provided on the transparent conductive film and the transparent conductive film is partially exposed, a contact pad is made to make contact with the above described exposed transparent conductive film after the polarizing plate is provided so that static electricity is removed, and the above described liquid crystal display panel and the above described touch panel are pasted together using a UV curing resin after the above described contact pad is made to make contact with the above described exposed transparent conductive film.

This manufacturing method can be provided as a manufacturing method for an IPS type liquid crystal display device inside which a touch panel is mounted where reduction in the thickness of a liquid crystal display device is possible and the problem with the visibility as in the case where a touch panel is mounted on the liquid crystal display panel can be solved.

Yet another aspect of the present invention provides a liquid crystal display device, comprising a liquid crystal display panel and a resistance film type touch panel mounted on the liquid crystal display panel, wherein a transparent conductive film is formed on a surface of the above described liquid crystal display panel and a polarizing plate is further provided on the transparent conductive film and the transparent conductive film is partially exposed, the polarizing plate of the above described liquid crystal display panel and the above described touch panel are pasted together using an adhesive, and the transparent conductive film provided on the above described liquid crystal display panel is in such a state as not to be grounded.

In this configuration also, reduction in the thickness of the liquid crystal display device is possible, and a liquid crystal display device inside which a touch panel is mounted where the problem with the visibility as in the case where a touch panel is mounted on the liquid crystal display panel can be solved can be provided.

Still yet another aspect of the present invention provides a liquid crystal display device comprising a liquid crystal display panel and a touch panel mounted on the liquid crystal display panel, wherein a transparent conductive film in an electrically floating state is provided on a surface of said liquid crystal display panel, and a polarizing plate is provided on the transparent conductive film and the transparent conductive film is partially exposed, and the polarizing plate of said liquid crystal display panel and said touch panel are pasted together using an adhesive.

In this configuration also, reduction in the thickness of the liquid crystal display device is possible, and a liquid crystal display device inside which a touch panel is mounted where the problem with the visibility as in the case where a touch panel is mounted on the liquid crystal display panel can be solved can be provided.

### EFFECTS OF THE INVENTION

The present invention can provide a liquid crystal display device inside which a touch panel is mounted where reduction in the thickness of the liquid crystal display device is possible and the problem with the visibility as in the case where a touch panel is mounted on the liquid crystal display panel can be solved.

### BRIEF DESCRIPTION OF THE DRAWINGS

FIG. 1 is a diagram showing a configuration where a touch panel 11 is provided above the liquid crystal display panel according to the present invention;

FIG. 2 is a diagram showing the liquid crystal display panel according to the present invention as viewed from the side;

FIG. 3 is a diagram illustrating how static electricity is removed using a jig;

FIG. 4 is a cross sectional diagram showing the configuration of the liquid crystal display device on which a touch panel is mounted according to the present invention;

FIG. 5 is a graph comparing the time for discharging static electricity when the conductive resin is removed and the time for discharging static electricity when a conductive resin is provided;

FIG. 6 is a diagram illustrating a method for removing static electricity generated after the assembly of a liquid crystal display on which a touch panel is mounted in the case of the configuration shown in FIG. 4;

FIG. 7 is a diagram showing the configuration of the touch panel 11 according to the present embodiment;

FIG. 8 is a diagram corresponding to Embodiment 3 of the present invention;

FIG. 9 is a diagram showing a configuration where a touch panel 11 is provided above a liquid crystal display panel according to the prior art;

FIG. 10 is a diagram showing a liquid crystal display panel according to the prior art as viewed from the top;

FIG. 11 is a diagram showing a liquid crystal display panel according to the prior art as viewed from the side, and shows a configuration where a touch panel 11 is provided above the liquid crystal display panel;

FIG. 12 is a diagram illustrating a method for removing static electricity with which the polarizing plate 1 and the transparent conductive film 8 are charged;

FIG. 13 is a diagram illustrating a new problem; and

FIG. 14 is a diagram showing an enlargement of the portion where a problem arises in FIG. 13.

### EXPLANATION OF SYMBOLS

1 polarizing plate
2 transparent substrate
3 transparent substrate
4 conductive resin
5 driver chip
6 flexible printed circuit board
7 mold frame
8 transparent conductive film
10 static electricity
11 touch panel
12 adhesive
13 bubbles
14 extending portion of flexible printed circuit board
15 controller IC
16 upper electrode of touch panel
17 lower electrode of touch panel
18 light source
19 light guiding plate
20 jig
111 upper substrate of touch panel
112 lower substrate of touch panel
161 silver wire connected to upper electrode of touch panel
162 silver wire connected to upper electrode of touch panel
171 silver wire connected to lower electrode of touch panel
172 silver wire connected to lower electrode of touch panel

### DETAILED DESCRIPTION OF THE INVENTION

### (Best Mode for Carrying Out the Invention)

In the following, the present invention is described using embodiments.

### Embodiment 1

First, a liquid crystal display panel where a conductive resin 4 is higher than a polarizing plate 1 provided on a transparent substrate 2 is used in order to meet the demand for thinner displays, and furthermore, a configuration is provided where no air layer intervenes between a touch panel 11 and a liquid crystal display panel, in order to meet the demand for higher visibility in the case where the touch panel 11 is mounted on a liquid crystal display panel. In the case where there is an air layer between the touch panel 11 and the liquid crystal display panel, external light is reflected in the interface between the touch panel 11 and the air layer, and therefore, the configuration is provided in order to increase the visibility by preventing reflection of external light.

A configuration where the touch panel 11 and the liquid crystal display panel are pasted together through an adhesive layer is provided as a configuration where no air layer intervenes between the touch panel 11 and the liquid crystal display panel. Here, according to the present invention, it is necessary to satisfy the demand for thinner displays at the same time, and therefore, it is necessary to reduce the thickness of the adhesive layer 12. In the case where a thin adhesive layer is used, however, it was found that a new problem arose.

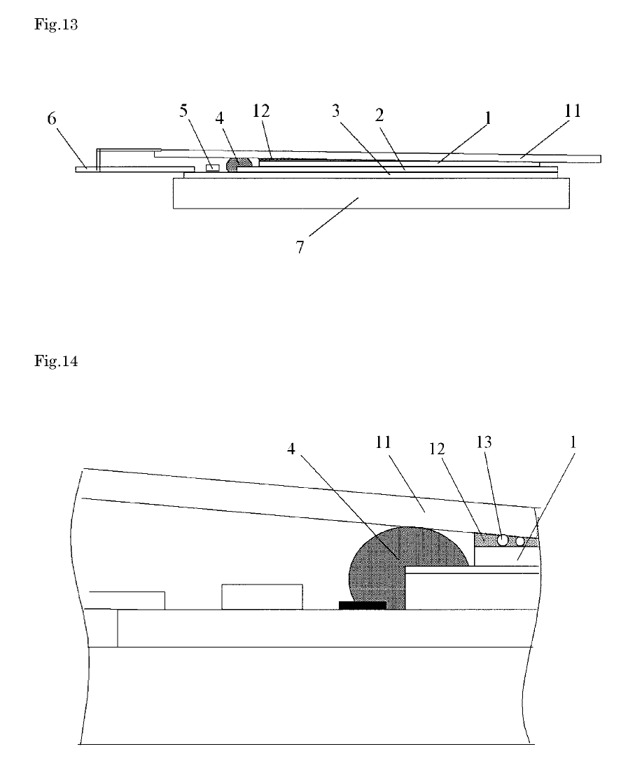

FIG. 13 is a diagram for illustrating the above described new problem. As shown in FIG. 13, in the case where the conductive resin 4 is higher than the polarizing plate 1 and the adhesive layer 12 is thin, the touch panel 11 makes contact with the conductive resin 4, and it was found that a problem arose, such that the touch panel 11 could not be pasted to the liquid display panel well.

This can happen in the case where the transparent substrate 2 has a thickness of 0.1 mm or more and 0.2 mm or less, the polarizing plate 1 has a thickness of 0.12 mm and the conductive resin is higher than the polarizing plate 1 even when the thickness of the adhesive layer is added (in case where the adhesive layer is approximately 0.05 mm, for example).

FIG. 14 is a diagram showing an enlargement of a portion where a problem arises in FIG. 13. The figure shows a state where the conductive resin 4 is formed so as to be higher than the polarizing plate 1 and the adhesive layer 12 is thin, so that the touch panel 11 makes contact with the conductive resin 4.

In this case, the touch panel 11 and the conductive resin 4 make contact (interfere with each other), and thus, a problem arises, such that there are bubbles between the touch panel 11 and the polarizing plate 1, causing deterioration in the quality of the display.

Therefore, in this configuration, the problem with the visibility in the case where a touch panel is mounted on a liquid crystal display panel can be solved to a certain extent, and reduction in the thickness of the liquid crystal display device is possible, but another problem arises, such that there are bubbles in the adhesive layer between the touch panel 11 and the polarizing plate 1.

Here, a means for preventing the conductive resin from exceeding the height of the polarizing plate by reducing the thickness of the conductive resin to approximately 0.1 mm is possible. In this case, however, there is a risk that the conductive resin may become disconnected, nothing can be displayed before static electricity is discharged when the conductive resin is disconnected, and inspection becomes difficult during the manufacturing process, making the productivity significantly lower.

### Embodiment 2

Another example of a means for solving the problem which arises in Example 1 is described below.

The problem is caused by the conductive resin 4 in the configuration described in Example 1, and when the conductive resin 4 is removed, the touch panel 11 and the conductive resin 4 can be prevented from making contact.

However, the conductive resin is essential as a means for removing static electricity with which the second substrate is charged in the case where electrodes for controlling the liquid crystal layer are provided on one substrate and no electrodes are provided on a second substrate in the configuration, for example in IPS type liquid crystal display devices.

Accordingly, the effects of removing the conductive resin 4 are first examined.

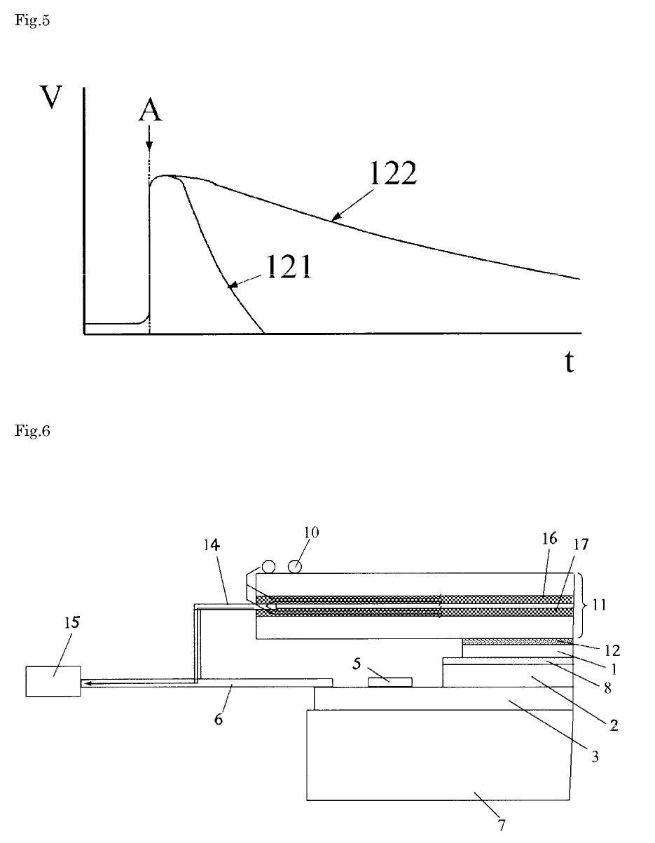

FIG. 5 compares the time for discharging static electricity between cases where the conductive resin is removed as in the configuration shown in FIG. 2 and a conductive resin is provided as in the configuration shown in FIG. 12.

In FIG. 5, 121 indicates the degree of change in the static electricity in the case where a conductive resin is provided, and 122 indicates the degree of change in the static electricity in the case where no conductive resin is provided. A indicates the point in time when the display is charged with static electricity. Here, the lateral axis in FIG. 4 indicates the elapsed time (t) and the longitudinal axis indicates static electricity (V).

As can be seen from FIG. 5, in the case where a conductive resin is provided, so that the display is grounded, static electricity can be immediately removed, while in the case where no conductive resin is provided, so that the display is not grounded, the static electricity gradually decreases as time elapses, but a considerable amount of time is required before the static electricity is completely removed.

Therefore, in the present example, it is necessary to find how the static electricity can be removed in the case where no conductive resin is provided.

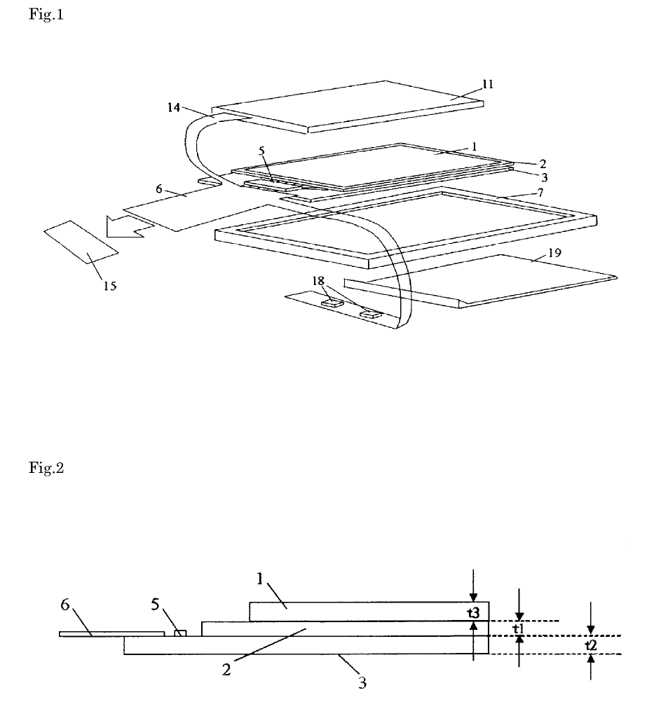

FIG. 1 is a diagram showing the configuration in the case where a touch panel 11 is provided above the liquid crystal display panel according to the present invention.

The liquid crystal display panel according to the present invention is a so-called IPS type liquid crystal display panel having a configuration where electrodes for controlling the liquid crystal layer are provided on one of the pair of substrates forming the liquid crystal display panel.

This liquid crystal display panel is formed of a larger transparent substrate 3 and a smaller transparent substrate 2 which overlap, and a liquid crystal layer sandwiched between these transparent substrates. In the case of an IPS type liquid crystal display panel, the larger transparent substrate 3 is a TFT substrate on which TFT's are provided, and the smaller transparent substrate 2 is referred to as color filter substrate.

A driver chip 5 for transmitting a signal for controlling the liquid crystal layer is provided in a portion on the transparent substrate 3 which does not overlap with the transparent substrate 2.

In addition, a flexible printed circuit board 6 (hereinafter referred to as FPC 6) for transmitting a signal to the driver chip 5 is provided on the side of the transparent substrate 3.

In addition, the liquid crystal display panel is provided on the upper side of the mold frame 7, and a light guiding plate 19 which forms the backlight is provided on the lower surface of the mold frame 7. Here, in one end portion of the light guiding plate 19, a light source 18 (for example LED's) is provided on the flexible printed circuit board, which extends from the FPC6.

In addition, the flexible printed circuit board 14 (hereinafter FPC 14) which extends from the FPC 6 is connected to a touch panel 11 provided above the liquid crystal display panel.

FIG. 2 is a diagram showing a liquid crystal display panel used to meet the demand for thinner displays according to the present invention as viewed from the side.

As shown in FIG. 2, the liquid crystal display panel is formed so that a transparent substrate 2 overlaps with a transparent substrate 3. In addition, a transparent conductive film (not shown) is provided on the transparent substrate 2 and a polarizing plate 1 is further provided on this transparent conductive film. A glass substrate having a thickness of 0.1 mm or more and 0.2 mm or less is used as the transparent substrate 3, and a glass substrate having a thickness of 0.1 mm or more and 0.2 mm or less is used as the transparent substrate 2 in the present invention, in order to meet the demand for thinner liquid crystal display devices. A polarizing plate having a thickness of 0.12 mm is used as the polarizing plate 1. Here, there is an error margin of approximately 25 μm in the manufacture of the polarizing plate 1, and thus, the actual thickness of the polarizing plate 1 is 0.12 mm±25 μm. The present invention is characterized in that the transparent conductive film provided on the transparent substrate 2 is not electrically grounded. Here, not electrically grounded means an electrically floating state; in other words, that the transparent conductive film and the grounded terminal portion are not connected as in the prior art. That is to say, according to the present invention, no conductive resin is provided, and naturally, no conductive resin is higher than the transparent substrate 2 or the polarizing plate 1.

Here, in the liquid crystal display device on which the touch panel 11 described in the present embodiment is mounted, static electricity is removed using a jig, as described above, before the touch panel 11 is pasted to the liquid crystal display panel.

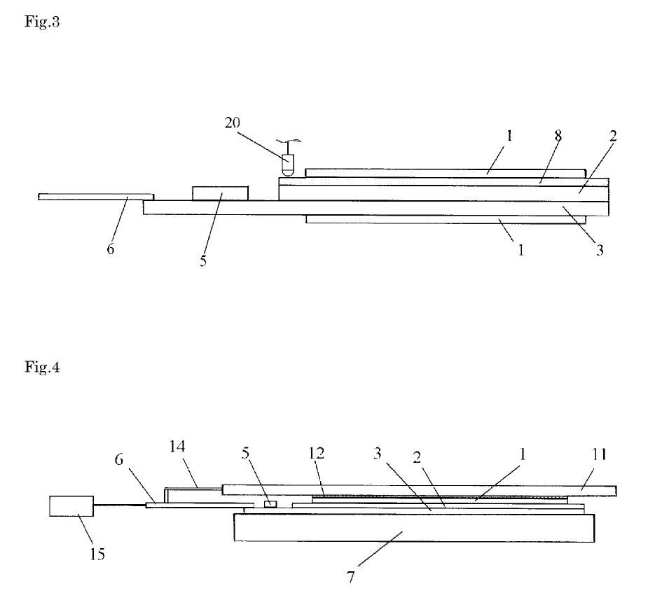

FIG. 3 is a diagram showing how static electricity is removed using a jig. The jig 20 is made to make contact with the transparent conductive film provided on the transparent substrate 2 so that static electricity is removed before being pasted to the touch panel 11.

When static electricity is removed in this manner, static electricity on the transparent substrate 2 side can be removed without providing a conductive resin.

FIG. 4 shows a state where a liquid crystal display panel and a touch panel 11 are pasted together through an adhesive layer after static electricity is removed using the jig shown in FIG. 3. Here, according to the present invention, a UV curing resin is used for the adhesive layer.

As shown in FIG. 4, in the liquid crystal display panel formed of a transparent substrate 3 and a transparent substrate 2, a transparent conductive film is provided on the transparent substrate 2, and a polarizing plate 1 is further provided on this transparent conductive film. Here, a polarizing plate is provided on the rear side of the transparent substrate 3.

In addition, the liquid crystal display device is formed by mounting a touch panel in such a manner that the polarizing plate 1 and the touch panel 11 are pasted together using an adhesive 12, for example a UV curing resin, between the polarizing plate 1 and the touch panel 11 in the liquid crystal display panel. The UV curing resin is a paste and printed on the printed on the polarizing plate 1 of the liquid crystal display panel through screen printing, and after that, the touch panel 11 is pasted to the polarizing plate, and then, the adhesive is thermally cured and hardened. Here, the liquid crystal display panel is supported by a mold frame 7, for example, in the case of a cellular phone.

Accordingly, this configuration allows for thinner liquid crystal display devices, and can provide a liquid crystal display device on which a touch panel can be mounted, so that the problem with the visibility as in the case where a touch panel is mounted on a liquid crystal display panel can be solved.

FIG. 6 is a diagram illustrating a method for removing static electricity generated after the assembly of the liquid crystal display device on which a touch panel is mounted, as in the case of the configuration shown in FIG. 4.

The touch panel 11 is connected to an extending portion 14 of the FPC 6 connected to the touch panel 11, and static electricity is removed via this FPC 6 by means of a controller IC 15.

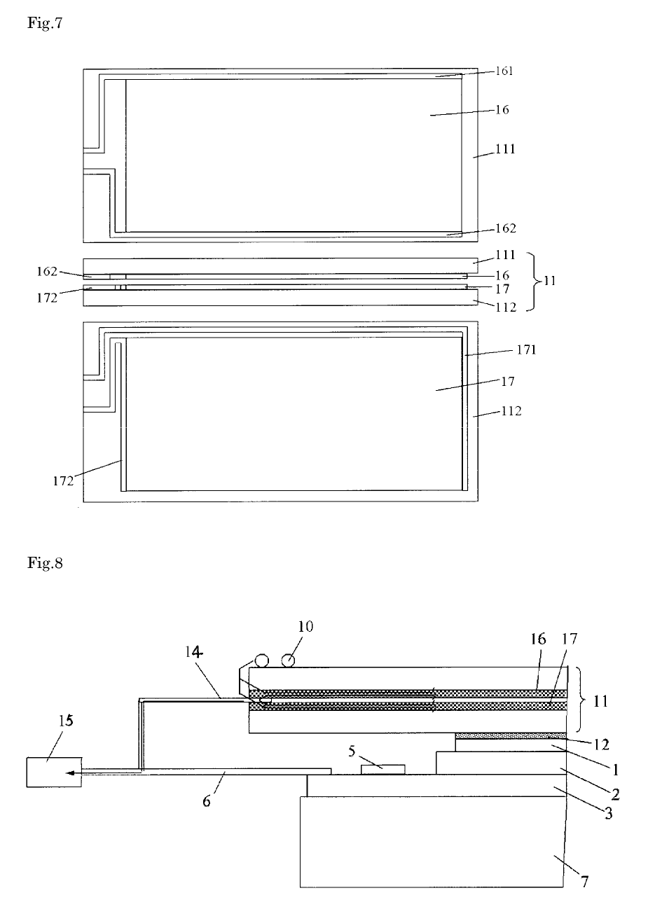

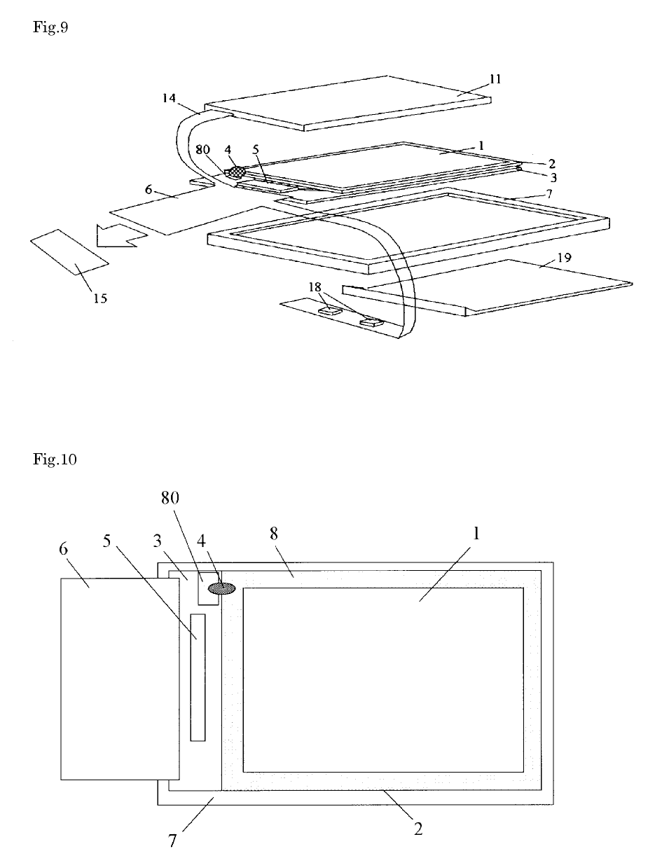

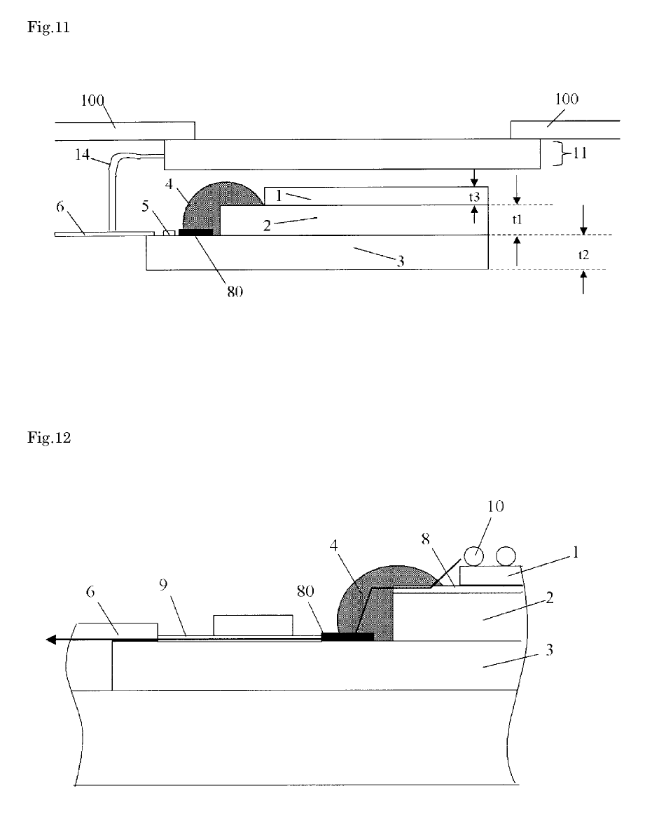

FIG. 7 is a diagram showing the configuration of the touch panel 11 according to the present embodiment.

The top in FIG. 7 shows the positional relationship between the upper electrode (formed of a transparent conductive film, such as of ITO) provided on the upper substrate of the touch panel 11 and a silver wire. In addition, the center in FIG. 7 is a cross section showing the touch panel 11. The bottom in FIG. 7 shows the positional relationship between the lower electrode (formed of a transparent conductive film, such as of ITO) provided on the lower substrate of the touch panel 11 and a silver wire.

A transparent conductive film 16 is provided on the surface of the upper substrate 111 in the touch panel 11, and silver wires 161 and 162 are provided along the two facing sides of this transparent conductive film 16. Here, the silver wires 161 and 162 are connected to the extending portion 14 of the FPC 6. A transparent conductive film 17 is provided on the surface of the lower substrate 112 in the touch panel 11, and silver wires 171 and 172 are provided along the two facing sides of this transparent conductive film 17, where the above described silver wires 161 and 162 on the upper substrate 111 are not provided. Here, the silver wires 161, 162, 171 and 172 are connected to the extending portion 14 of the FPC 6.

### Embodiment 3

In the configuration in Embodiment 2, though no conductive resin is provided, a transparent conductive film (of ITO, for example) is provided on the transparent substrate 2. As described above, in the case where there is no transparent conductive film, a considerable amount of time is required to remove static electricity, and thus, a long time is required for inspection with the light turned on before the touch panel can be pasted on the display, and therefore, the productivity is affected. However, in the case where the touch panel 11 is mounted on the liquid crystal display panel once, even though a considerable amount of time is required, static electricity generated later can be removed through the touch panel 11, and therefore, as shown in FIG. 8, it is possible to provide a liquid crystal display device on which a touch panel is mounted by removing the transparent conductive film. In this case, a problem arises with removal of static electricity with which the liquid crystal display panel is charged after the polarizing plate 1 is pasted to the liquid crystal display panel and before the touch panel is mounted, but there are possible measures, such as spending sufficient time before natural discharge, or pressing the jig described in FIG. 3 against the whole (many points) of the polarizing plate 1, so that the time for discharge is shortened.

1. An IPS type liquid crystal display device inside which a touch panel is mounted, comprising a liquid crystal display panel and a resistance film type touch panel mounted on the liquid crystal display panel, wherein
said liquid crystal display panel is an IPS type liquid crystal display panel formed of two substrates of a different size and a liquid crystal layer provided between the two substrates, and electrodes for controlling said liquid crystal layer are provided on the larger substrate,
a transparent conductive film is formed on the surface of the smaller substrate and a polarizing plate is further provided on the transparent conductive film,
the space between the polarizing plate provided on said smaller substrate and said touch panel is filled in with an adhesive, and
the transparent conductive film provided on the surface of said smaller substrate is in such a state as not to be grounded.

2. The IPS type liquid crystal display device inside which a touch panel is mounted according to claim 1, wherein
a number of scanning lines and a number of video signal lines which cross the number of scanning lines are provided on said larger substrate, pixels are formed in regions surrounded by said number of scanning lines and said number of video lines, switching elements are provided so as to correspond to intersections between said number of scanning lines and said number of video signal lines for each pixel, pixel electrodes are connected to the switching elements, and furthermore, a common electrode for controlling said liquid crystal layer which has a different potential from the pixel electrodes is provided, and
the electrodes for controlling said liquid crystal layer are said pixel electrodes and said common electrode.

3. The IPS type liquid crystal display device inside which a touch panel is mounted according to claim 1, wherein
said smaller substrate has a thickness of 0.1 mm or more and 0.2 mm or less.

4. The IPS type liquid crystal display device inside which a touch panel is mounted according to claim 1, wherein
the adhesive with which the space between the polarizing plate provided on said smaller substrate and said touch panel is a UV curing resin.

5. The IPS type liquid crystal display device inside which a touch panel is mounted according to claim 4, wherein
said UV curing resin has a thickness of 0.05 mm±40 μm.

6. The IPS type liquid crystal display device inside which a touch panel is mounted according to claims 1, wherein
one end of a flexible printed circuit board is connected to said panel, and
another end of the flexible printed circuit board is connected to a controller IC.

7. The IPS type liquid crystal display device inside which a touch panel is mounted according to claim 6, wherein
said controller IC removes static electricity with which said touch panel is charged.

8. The IPS type liquid crystal display device inside which a touch panel is mounted according to claim 1, wherein
said polarizing plate has a thickness of 0.12 mm±25 μm.

9. A liquid crystal display device inside which a touch panel is mounted, comprising a liquid crystal display panel and a resistance film type touch panel mounted on the liquid crystal display panel, wherein
said liquid crystal display panel is a liquid crystal display panel formed of two substrates of a different size and a liquid crystal layer between the two substrates, and a pair of electrodes for controlling said liquid crystal layer is provided on the larger substrate,
a transparent conductive film is formed on the surface of the smaller substrate and a polarizing plate is further provided on the transparent conductive film,
the polarizing plate provided on said smaller substrate and said touch panel are pasted together with an adhesive, and
the transparent conductive film provided on the surface of said smaller substrate is in an electrically floating state.

10. The liquid crystal display device inside which a touch panel is mounted according to claim 9, wherein
said liquid crystal display panel is an IPS type liquid crystal display panel where a pair of electrodes for controlling said liquid crystal layer is provided on the larger substrate.

11. The liquid crystal display device inside which a touch panel is mounted according to claim 10, wherein
a number of scanning lines and a number of video signal lines which cross the number of scanning lines are provided on said larger substrate, pixels are formed in regions surrounded by said number of scanning lines and said number of video lines, switching elements are provided so as to correspond to intersections between said number of scanning lines and said number of video signal lines for each pixel, pixel electrodes are connected to the switching elements, and furthermore, a common electrode for controlling said liquid crystal layer which has a different potential from the pixel electrodes is provided, and
said pair of electrodes is a pixel electrode and a common electrode.

12. The liquid crystal display device inside which a touch panel is mounted according to claim 9, wherein
said smaller substrate has a thickness of 0.1 mm or more and 0.2 mm or less.

13. The liquid crystal display device inside which a touch panel is mounted according to claim 9, wherein
the adhesive provided between the polarizing plate provided on said smaller substrate and said touch panel is a UV curing resin.

14. The liquid crystal display device inside which a touch panel is mounted according to claim 9, wherein
said polarizing plate has a thickness of 0.12 mm±25 μm.

15. A liquid crystal display device, comprising a liquid crystal display panel and a resistance film type touch panel mounted on the liquid crystal display panel, wherein
a transparent conductive film is formed on a surface of said liquid crystal display panel and a polarizing plate is further provided on the transparent conductive film and the transparent conductive film is partially exposed,
the polarizing plate of said liquid crystal display panel and said touch panel are pasted together using an adhesive, and
the transparent conductive film provided on said liquid crystal display panel is in such a state as not to be grounded.

16. The liquid crystal display device inside which a touch panel is mounted according to claim 15, wherein
said liquid crystal display panel is formed of a pair of transparent substrates, and
each transparent substrate in the pair has a thickness of 0.1 mm or more and 0.2 mm or less.

17. The liquid crystal display device inside which a touch panel is mounted according to claim 15, wherein
said adhesive is a UV curing resin.

18. The liquid crystal display device inside which a touch panel is mounted according to claim 17, wherein
said UV curing resin has a thickness of 0.05 mm±40 μm.

19. The liquid crystal display device inside which a touch panel is mounted according to claim 15, wherein
said polarizing plate has a thickness of 0.12±25 μm.
